(19) United States
(12) Patent Application Publication
(10) Pub. No.: US 2010/0051545 A1
(43) Pub. Date: Mar. 4, 2010

(54) MEMBRANE MODULE PROTECTION

(76) Inventors: Warren Thomas Johnson, New South Wales (AU); Thomas William Beck, New South Wales (AU); Fufang Zha, New South Wales (AU)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/594,376

(22) PCT Filed: Apr. 4, 2008
(86) PCT No.: PCT/AU08/00491

§ 371 Date: Oct. 2, 2009

(30) Foreign Application Priority Data
Apr. 4, 2007 (AU) 2007901821

(51) Int. Cl. B01D 65/08; B01D 63/04; B01D 69/08

(52) U.S. Cl. 210/636; 210/321.6; 210/321.69; 210/321.88

(57) ABSTRACT

A filtration system for removing fine solids from a liquid suspension comprising a vessel for containing the liquid suspension, one or more permeable, membranes (9) within the vessel, means for providing a pressure differential across walls of the membranes (9) such that some of the liquid suspension passes through the walls of the membranes (9) to be drawn off as permeate and means for withdrawing the permeate from the membranes. A screen (8) is positioned in a flow path of the liquid suspension through to the membrane walls.

### TECHNICAL FIELD

The invention relates to membrane filtration modules having one or more hollow permeable membranes mounted therein and more particularly to protection for such membrane modules.

### BACKGROUND OF THE INVENTION

During the membrane filtration process, foreign particles/materials contained in the feed approach the membrane surface and are caught in the membrane module. Those particles cause membrane fouling and can clog membrane modules. Liquid backwash, air scouring and chemical cleaning are common means to remove the fouled materials. However, the membrane modules still often suffer from packing by fibrous materials or damage by sharp materials or objects. Typically fibrous materials or trash may be caught around membranes and inside the membrane groups or bundles when wastewater or mixed liquor from a biological system is filtered. Another example is the seawater pre-treatment with membrane filtration where sharp shells from sea water often cause damage to membranes.

Different methods have been proposed to protect the membrane modules from damage by foreign materials and objects. Pre-screen of feed is a common method to protect membrane modules from damage by large size materials. In membrane bioreactors, a screen with perforated mesh is inserted between the biological tank and the membrane tank to protect the membranes and modules. In this arrangement, a large screen has to be used and special aerators need to be installed to clean the screen.

One known method of protecting membranes includes holding a bundle of capillaries together with an open sleeve or casing. The coarse materials, like hair, are filtered by the sleeve so that these materials can not intrude into the inner section of the membrane bundle. However, the method neglects a fact that the materials smaller than the openings can pass through the open sleeve, move towards the membrane surface and inner fibre bundles, and agglomerate around and inside the fibre bundles. It is difficult for these materials to be removed out of the open sleeve. Gradually these materials accumulate inside the membrane bundle and on the inner surface of the sleeve and the bundles eventually become packed with these materials.

### SUMMARY OF THE INVENTION

It is an object of the present invention to overcome or ameliorate at least one of the disadvantages of the prior art, or to provide a useful alternative.

According to one aspect, the present invention provides a filtration system for removing fine solids from a liquid suspension comprising:

a vessel for containing said liquid suspension;

one or more permeable, membranes within the vessel;

means for providing a pressure differential across walls of said membranes such that some of the liquid suspension passes through the walls of the membranes to be drawn off as permeate;

a screen positioned in a flow path of the liquid suspension through to said membrane walls; and

means for withdrawing permeate from the membranes.

According to another aspect, the present invention provides a filtration system comprising:

a membrane module comprising a plurality of permeable membranes, each of the membranes having a first end and a second end, the membranes having one of said ends extending from and mounted to at least one potting head, and a screen surrounding the membranes.

According to another aspect, the present invention provides a filtration system comprising:

a membrane module comprising a plurality of permeable membranes, each of the membranes having a first end and a second end, the membranes having one of said ends extending from and mounted to at least one potting head, said module having an upper and a lower end;

a screen surrounding the membranes and extending between said upper and lower ends of said module; and

an opening being provided in said screen at or adjacent said upper end of the module.

In one embodiment, said opening is provided by peripherally spacing an end of said screen from said upper end of the module. In another embodiment, said opening is provided by extending said screen to below said upper end of the module. Preferably, the upper end of said module comprises said at least one potting head.

Preferably said screen is a fine screen. For preference, the aperture size of the screen is between about 625 μm² to about 25×10⁶ μm² and more preferably, between about 1×10⁴ μm² to about 1×10⁶ μm².

Preferably, the screen is connected to and extends from said potting head.

In one form of the invention, the membranes are sealed at the first end and open at the second end to allow removal of a filtrate, though it will be appreciated that in some forms of the invention the membranes are open at both ends to allow filtrate removal from both ends. Preferably the membranes comprise hollow fibre membranes. For preference, the fibres are arranged in close proximity to one another and mounted in a bundle in a substantially taut manner between an upper potting head and a lower potting head to prevent excessive movement therebetween. Preferably, the fibres are substantially uniformly mounted in the lower potting head relative to a distributed array of aeration holes in the lower potting head, wherein the aeration holes are sized and located such that bubbles, formed by a pressurized gas passing therethrough when the module is immersed in a liquid, pass substantially uniformly between the fibres.

For preference the vessel includes a plenum chamber beneath the lower potting head through which the pressurized gas is introduced, and wherein the plenum chamber includes an aperture substantially beneath the aeration holes for allowing egress of contaminants.

For preference, the lower potting head is connected to a source of the pressurized gas, and the fibres and screen are arranged to be vibrated by the gas bubbles.

According to another aspect, the present invention provides a membrane module, comprising a plurality of permeable membranes,

said membranes being arranged in close proximity to one another to form an array,

the module having a header in which one end of each of the membranes is mounted, and

a screen surrounding said array of membranes.

For preference, the screen extends from said header. Preferably, the screen is connected to the header. Preferably, said screen is a fine screen. For preference, the aperture size of the screen is between about 625 μm² to about 4×10⁶ μm² and more preferably, between about 1×10⁴ μm² to about 1×10⁶ μm².

Preferably, the header is connected to a source of pressurized gas so as to permit formation of gas bubbles such that, in use, the bubbles move past the surfaces of and vibrate said membranes and said screen to dislodge fouling materials therefrom.

For preference, the porous membranes comprise hollow fibre membranes. Preferably, the fibre membranes are arranged in bundles surrounded by the screen.

According to another aspect, the present invention provides a method for filtering a feed liquid, the method comprising:

providing a vessel;

providing a membrane module, the membrane module comprising:
a plurality of permeable membranes, and
a fine screen surrounding the plurality of membranes,
wherein the membrane module is contained within the vessel; and
the membranes comprising a plurality of pores and an outer surface,

providing a feed liquid to the vessel;

applying a transmembrane pressure to the membranes in the module, whereby a filtrate passes through pores in the membranes, thereby producing a concentrated feed comprising a fouling material in the vessel; and

removing the fouling material from the vessel.

Preferably, the membranes are mounted in a header in close proximity to one another so as to prevent excessive movement therebetween. For preference, the membranes form an array.

Some module arrangements have holes in the lower potting head for providing feed liquid to the membranes that may bypass a screen provided around the membranes. Although the low pressure drop across the screen due to its larger surface area means that most of the feed flow will still be screened, an additional screen can be fitted across the holes below the module, if required.

In one embodiment, the feed liquid is provided, at least in part, through a port in said module and fouling material is withdrawn through said port, said port having a selectively operable screen arranged such that feed flowing into said module is screened and fouling material flowing from said module is not screened.

By adding a fine mesh to the membrane module it is possible to provide a screen surface, which can provide a relatively large screen at a modest cost, without the need for external capital equipment. In the case of a membrane arrangements using aeration scouring to clean the membranes within the module, the aeration process normally used to clean the module, may also vibrate the screen, and dislodge any material therefrom that has accumulated. Dislodged material leaves the system through the normal drain-down process. So in addition to a backwashable screen, there is no need for a separate screens handling system as required in the prior art.

It will be appreciated by those skilled in the art that the present invention may be used with pressurised modules, membrane bioreactor modules, submerged modules or any variations thereof. The invention may also be applied to racks of modules rather than to the separate modules that make up the rack, by enclosing the rack of modules in the screen material.

### BRIEF DESCRIPTION OF THE DRAWINGS

Preferred embodiments of the invention will now be described, by way of example only, with reference to the accompanying drawings in which:

FIG. 1 shows a simplified cross-sectional elevation view of one embodiment of a membrane module in accordance with the present invention;

FIG. 2 shows a simplified cross-sectional elevation view of another embodiment of a membrane module in accordance with the present invention

FIG. 3 shows a simplified cross-sectional elevation view of another embodiment of a membrane module in accordance with the present invention;

FIG. 4 shows a simplified cross-sectional elevation view of another embodiment of a membrane module in accordance with the present invention;

FIG. 4A shows a sectional plan view taken along line 4A-4A of FIG. 4;

FIGS. 5A and 5B show a simplified cross-sectional elevation view of another embodiment of a membrane module in accordance with the present invention; and

FIG. 6 shows a simplified cross-sectional elevation view of another embodiment of a membrane module in accordance with the present invention.

### DESCRIPTION OF PREFERRED EMBODIMENTS

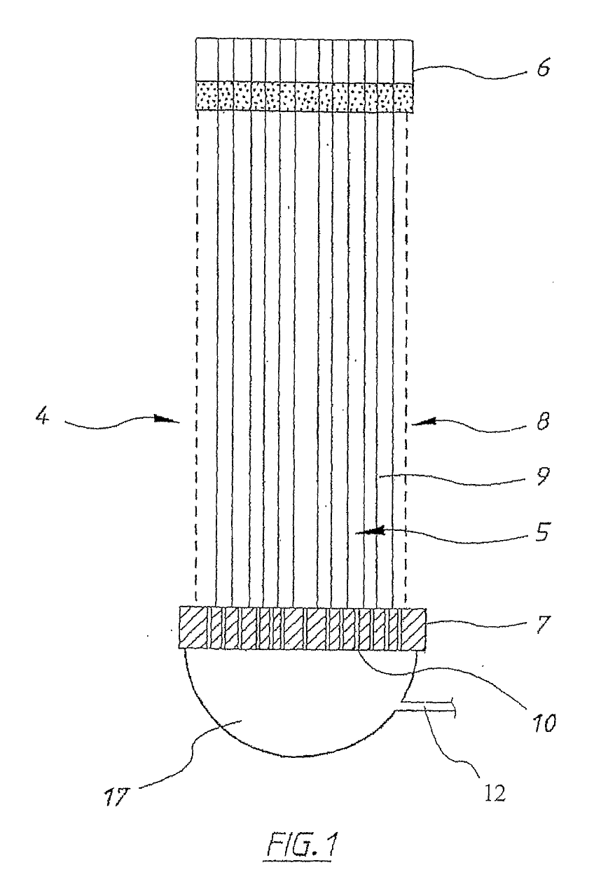

Referring to FIG. 1, the membrane module 4, according to this embodiment, comprises an array or bundle of hollow fibre membranes 5 extending longitudinally between upper and lower potting heads 6 and 7. A fine screen mesh 8 surrounds the array 5 and provides an initial screening of feed entering the module 4 while also serving to hold the fibres 9 in close proximity to each other and prevent excessive movement. The fibres 9 are open at the upper potting head 6 to allow for filtrate removal from their lumens and sealed at the lower potting head 7. The lower potting head 7 has a number of holes 10 uniformly distributed therein to enable gas/air to be supplied therethrough from a feed line 12 and plenum chamber 17 located below the aeration holes 10. The fibres are fixed uniformly within the potting heads 6 and 7 and the holes 10 are formed uniformly relative to each fibre 9 so as to provide, in use, a uniform distribution of gas bubbles between the fibres.

In use, the module 4 is arranged vertically in a feed tank (not shown). During filtration the filtrate is withdrawn from the top potting head 6 and filtrate collection chamber 11 through suction applied to the open ends of the membrane lumens. The suction produces a pressure differential across the membrane walls resulting in feed liquid being drawn from the feed tank through the screen 8 and into contact with the hollow fibre membranes 9. The screen 8 has apertures dimensioned to remove coarse contaminant matter within the feed liquid prior to its application to the membranes.

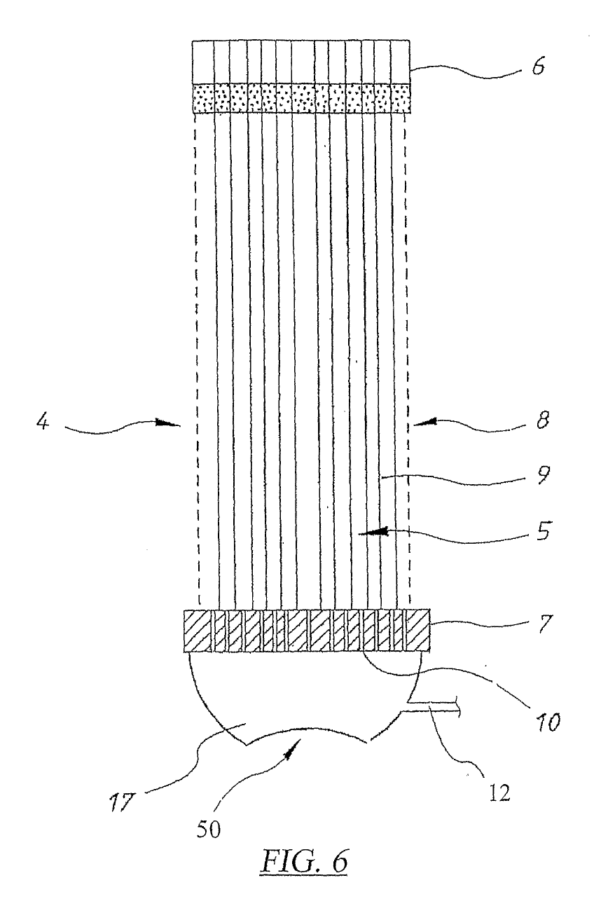

FIG. 6 illustrates an embodiment similar to that of FIG. 1, however plenum chamber 17 includes an aperture 50 formed beneath the feed line 12. In the present example, the aperture extends generally horizontally. In this embodiment, feed enters the membrane module primarily through the screen 8, and to a lesser extent through aperture 50. This feed is then applied to the fibres 9 in the usual manner. Concentrate and other solids/trash accumulated within the module 4 is able to egress via the aperture 50 either of its own accord under gravitational influence, or by virtue of gas bubble scouring, backwashing flows, drain down of the tank, or the like. To this end, it will be appreciated that the location of the aperture 50 does not substantively inhibit the ability to supply of gas/air through the feed line 12 for the purpose of bubble scouring.

Although this embodiment suffers some decrease in effectiveness due to the ingress of course contaminant matter through the aperture 50 (which is not protected by screen 8), this is generally balanced from a performance/practical perspective by advantages stemming from the free flow of concentrate and waste (including course contaminant matter) outwardly through aperture 50, typically during the backwash process.

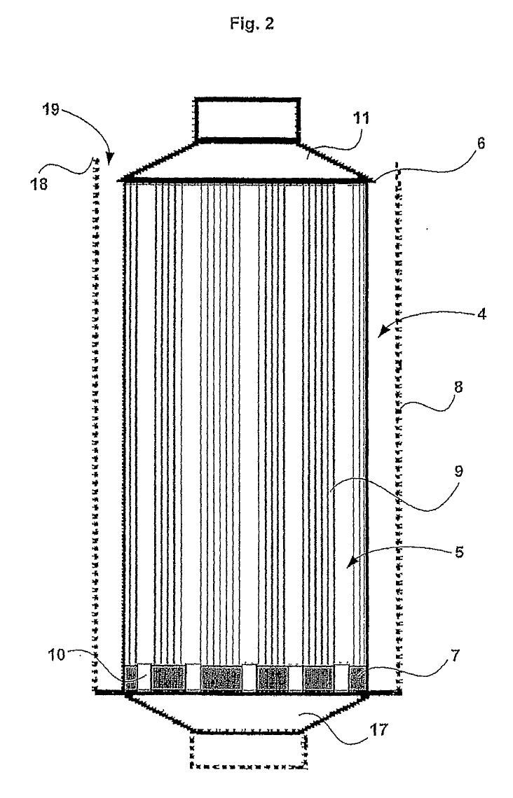

FIG. 2 shows a further embodiment of the invention where the screen 8 is spaced from the periphery of the module 4 while extending the full length of the module 4. The screen is attached to the lower potting head 7 but open at its upper end 18 adjacent the upper potting head 6 to define an opening 19. In use, feed flows through the screen 8 into contact with the membranes 9 mounted in the module 4. Concentrate produced during filtration, gas bubble scouring and backwashing flows out through the opening 19.

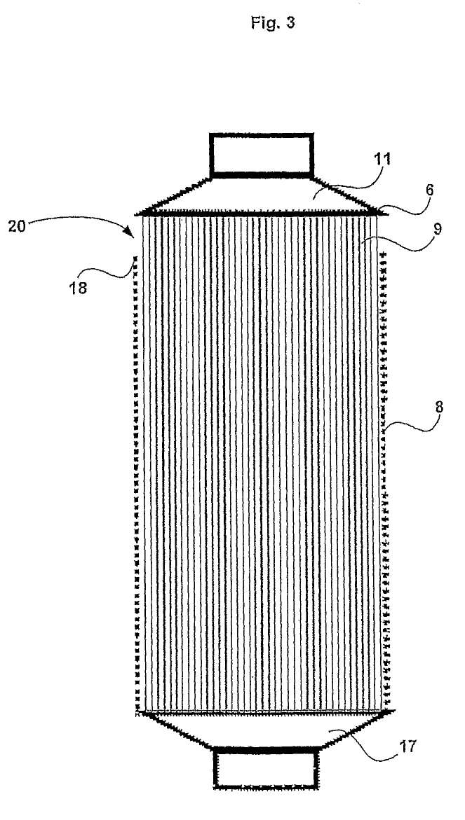

FIG. 3 shows a similar embodiment to that of FIG. 2, however, in this embodiment, the screen 8 does not extend fully to the upper potting head 6 and a gap or opening 20 is provided between the end 18 of the screen 8 and the upper potting head 6. This opening 20 again allows concentrate to flow therethrough. Alternatively, the gap or opening 20 may be formed in the screen itself but with a larger aperture size than the normal screen apertures to allow the concentrate to flow therethrough.

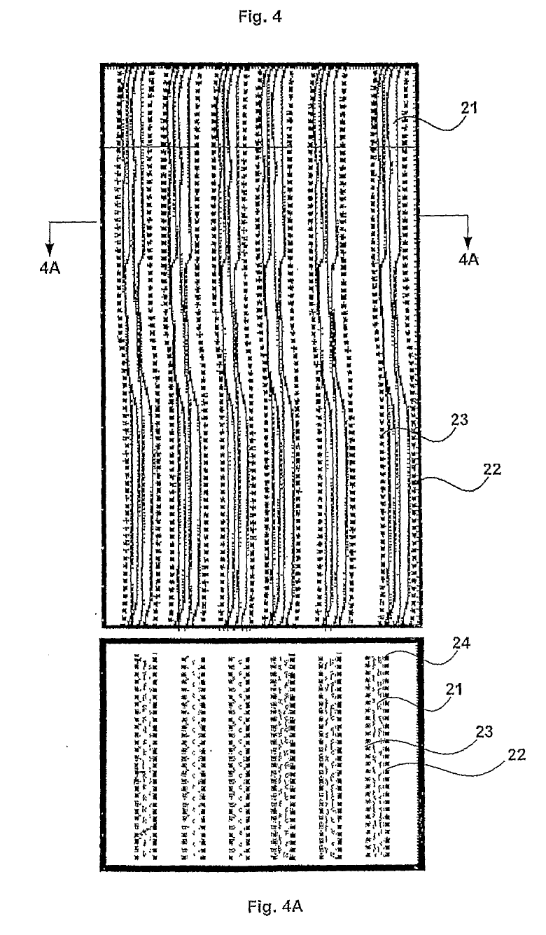

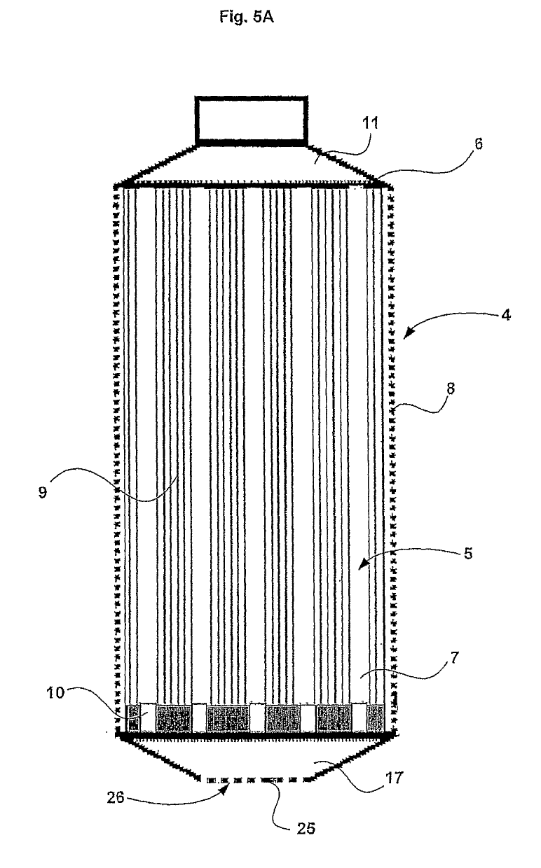

FIGS. 4 and 4A show an embodiment where fibre membrane mats 21 are used in the module. In this arrangement each mat 21 is provided with co-extensive protection screens 22 and 23 which are provided on each side of each mat 21 and extend between the upper and lower potting heads 6 and 7. As best shown in FIG. 4A, the screens 22 and 23 are open adjacent the edges 24 of the mats 21 to allow outward flow of concentrate.

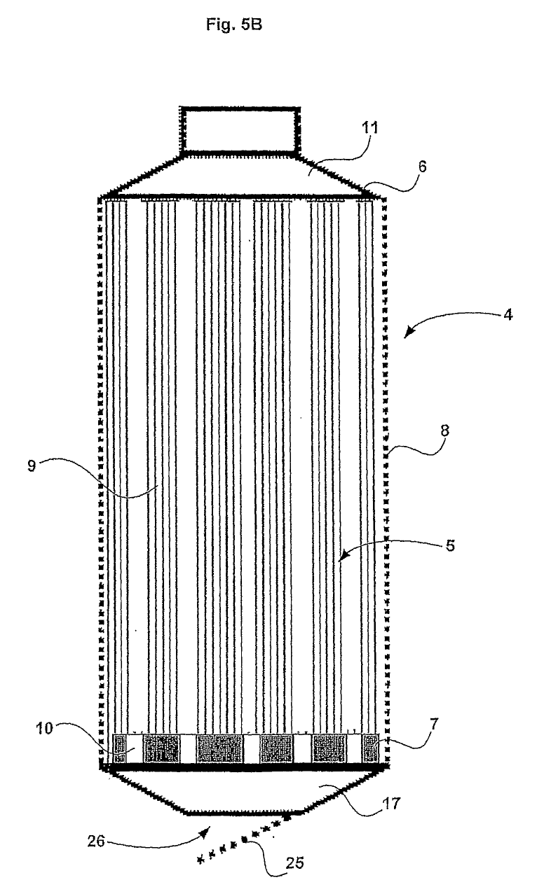

FIGS. 5A and 5B show a further embodiment where a selectively operable screen 25 is provided across a feed entry port 26. In this embodiment feed enters the membrane module through the port 26 and flows through screen 25 into the membrane module 4 where it is applied to the membranes 9 in the usual manner. When concentrate and other solids/trash accumulated within the module 4 is required to be removed, the screen 25 is opened as shown in FIG. 5B to allow free flow of concentrate and waste from the module 4 through port 26. It will be appreciated a similar effect could be achieved by having an inflow path which is screened and an outflow path which is unscreened. Similarly, other portions of the screen 8 could be provided with selectively operable openings to provide a similar advantageous operation.

Gas, typically air, is introduced into the bottom of the module 4 through holes 10, producing gas bubbles between fibres to scrub solids accumulated on membrane surfaces. The gas bubbles also result in vibrating and scouring of the screen 8 to remove accumulated screening therefrom. When the feed tank is drained following a backwash, the screenings dislodged from the screen 8 are also removed.

The gas bubble cleaning process and method may be used in conjunction with any standard backwashing regimes including liquid backwashing, pressurised gas backwashing, combinations of both, as well as with chemical cleaning and dosing arrangements.

The gas bubble cleaning process would normally be used in conjunction with the backwash stage, however, it may also be used continually during the filtration and backwash stages. Cleaning chemicals such as chlorine may be added to the gas providing the bubbles to further assist the cleaning process. Solids removed in the cleaning process may be intermittently or continually removed.

Screen aperture dimensions are chosen to reject debris entering the membrane module, but allow gas to escape during the gas bubble cleaning process. For finer screens a gas vent can be provided instead of relying on the gas passing out through the screen. The screen can be formed of self-supported hard material or a flexible material that allows swaying of the screen during the gas-bubbling cleaning process.

It will be appreciated that further embodiments and exemplifications of the invention are possible without departing from the spirit or scope of the invention described.

1. A filtration system for removing fine solids from a liquid suspension comprising:
a vessel for containing said liquid suspension;
one or more permeable, membranes within the vessel;
means for providing a pressure differential across walls of said membranes such that some of the liquid suspension passes through the walls of the membranes to be drawn off as permeate;
a screen positioned in a flow path of the liquid suspension through to said membrane walls; and
means for withdrawing permeate from the membranes.

2. A filtration system comprising:
a membrane module comprising a plurality of permeable membranes, each of the membranes having a first end and a second end, the membranes having one of said ends extending from and mounted to at least one potting head, and
a screen surrounding the membranes.

3. A filtration system comprising:
a membrane module comprising a plurality of permeable membranes, each of the membranes having a first end and a second end, the membranes having one of said ends extending from and mounted to at least one potting head,
said module having an upper and a lower end;
a screen surrounding the membranes and extending between said upper and lower ends of said module; and
an opening being provided in said screen at or adjacent said upper end of the module.

4. A filtration system according to claim 3, wherein said opening is provided by peripherally spacing an end of said screen from said upper end of the module.

5. A filtration system according to claim 3, wherein said opening is provided by extending said screen to below said upper end of the module.

6. A filtration system according to claim 5, wherein the upper end of said module comprises said at least one potting head.

7. A filtration system according to claim 1 wherein said screen is a fine screen.

8. A filtration system according to claim 7 wherein the aperture size of the screen is between about 625 μm² to about 25×10⁶ μm².

9. A filtration system according to claim 8 wherein the aperture size is between about 1×10⁴ μm² to about 1×10⁶ m².

10. A filtration system according to claim wherein the screen is connected to and extends from said potting head.

11. A filtration system according to claim 1 wherein the membranes are sealed at the first end and open at the second end to allow removal of a filtrate.

12. A filtration system according to claim 1 wherein the membranes comprise hollow fibre membranes.

13. A filtration system according to claim 12 wherein the fibres are arranged in close proximity to one another and mounted in a bundle in a substantially taut manner between an upper potting head and a lower potting head to prevent excessive movement therebetween.

14. A filtration system according to claim 13 wherein the fibres are substantially uniformly mounted in the lower potting head relative to a distributed array of aeration holes in the lower potting head, wherein the aeration holes are sized and located such that bubbles, formed by a gas passing therethrough when the module is immersed in a liquid, pass substantially uniformly between the fibres.

15. A filtration system according to claim 14 wherein the vessel includes a plenum chamber beneath the lower potting head through which the pressurized gas is introduced, and wherein the plenum chamber includes an aperture substantially beneath the aeration holes for allowing egress of contaminants.

16. A filtration system according to claim 14 wherein the lower potting head is connected to a source of the pressurized gas, and the fibres and screen are arranged to be vibrated by the gas bubbles.

17. A membrane module, comprising:
a plurality of permeable membranes, said membranes being arranged in close proximity to one another to form an array, the module having a header in which one end of each of the membranes is mounted and
a screen surrounding said array of membranes.

18. A membrane module according to claim 17 wherein the screen extends from said header.

19. A membrane module according to claim 18 wherein the screen is connected to the header.

20. A membrane module according to claim 17 wherein said screen is a fine screen.

21. A membrane module according to claim 20 wherein the aperture size of the screen is between about 625 μm² to about 25×10⁶ μm².

22. A membrane module according to claim 21 wherein the aperture size is between about 1×10⁴ μm² to about 1×10⁶ μm².

23. A membrane module according to claim 16 wherein the membranes are sealed at the first end and open at the second end to allow removal of a filtrate.

24. A membrane module according to claim 17 wherein the membranes comprise hollow fibre membranes.

25. A membrane module according to claim 24 the fibre membranes are arranged in bundles surrounded by the screen.

26. A membrane module according to claim 17 wherein the header is connected to a source of pressurized gas so as to permit formation of gas bubbles such that, in use, the bubbles move past the surfaces of and vibrate said membranes and said screen to dislodge fouling materials therefrom.

27. A method for filtering a feed liquid comprising the steps of:
providing a vessel;
providing a membrane module, the membrane module comprising:
a plurality of permeable membranes, and
a fine screen surrounding the plurality of membranes,
wherein the membrane module is contained within the vessel; and
the membranes comprising a plurality of pores and an outer surface,
providing a feed liquid to the vessel;
applying a transmembrane pressure to the membranes in the module, whereby a filtrate passes through pores in the membranes, thereby producing a concentrated feed comprising a fouling material in the vessel; and
removing the fouling material from the vessel.

28. A method for filtering a feed liquid according to claim 27 wherein the membranes are mounted in a header in close proximity to one another so as to prevent excessive movement therebetween.
